(19) United States
(12) Patent Application Publication
(10) Pub. No.: US 2023/0408320 A1
(43) Pub. Date: Dec. 21, 2023

(54) INFORMATION PROCESSING APPARATUS, INFORMATION PROCESSING METHOD, AND PROGRAM

(71) Applicant: Sony Group Corporation, Tokyo (JP)

(72) Inventors: Rui KAMADA, Tokyo (JP); Hiroki SAIJO, Tokyo (JP); Yoshinao SODEYAMA, Tokyo (JP); Kirill VANHEERDEN, Tokyo (JP); Yasunori KAWANAMI, Tokyo (JP); Naoki NISHIMURA, Tokyo (JP)

(73) Assignee: Sony Group Corporation, Tokyo (JP)

(21) Appl. No.: 18/248,060

(22) PCT Filed: Sep. 13, 2021
(86) PCT No.: PCT/JP2021/033493

§ 371 Date: Apr. 6, 2023

(30) Foreign Application Priority Data
Oct. 13, 2020 (JP) 2020-172280

(51) Int. Cl. G01F 23/292; B65G 47/90

(52) U.S. Cl. CPC G01F 23/292; B65G 47/905

(57) ABSTRACT

A light receiver 212u provided on the upper side and a light receiver 212d provided on the lower side with respect to the optical axis of a light emitter 211 generate light reception signals corresponding to the light reception intensity of emitted light from the light emitter 211. A liquid level state determiner 30 determines a liquid level state on the basis of a signal level difference between the light reception signal generated by the light receiver 212u and the light reception signal generated by the light receiver 212d. It is not required to perform processing of captured image data, and even in a case where a liquid temperature is substantially equal to the outside air temperature, the state of a liquid level can be easily grasped.

### TECHNICAL FIELD

The present invention relates to an information processing apparatus, an information processing method, and a program, and enables easy grasping of the state of a liquid level.

### BACKGROUND ART

Conventionally, in a case where a liquid is handled, for example, the liquid level of the liquid contained in a container is estimated, and estimation of the amount of liquid and conveyance control of the liquid are performed on the basis of the estimation result. For example, in Patent Document 1, the liquid level is continuously imaged from the outside of a container by an imaging device to grasp the state of the liquid level. Furthermore, in Patent Document 2, an arm having two temperature sensors in the vertical direction is brought into close contact with a container and moved in the vertical direction, and in a case where the temperature difference between the two temperature sensors exceeds a threshold, it is determined that the liquid level is between the temperature sensors.

### CITATION LIST

### Patent Document

Patent Document 1: Japanese Patent Application Laid-Open No. 2018-9847
Patent Document 2: Japanese Patent Application Laid-Open No. 5-60591

### SUMMARY OF THE INVENTION

### Problems to be Solved by the Invention

Meanwhile, in a case where the state of the liquid level is grasped using an imaging device as in Patent Document 1, performance capable of processing captured image data is required. Furthermore, in a case where the liquid level is determined on the basis of the temperature difference between two temperature sensors as in Patent Document 2, if a liquid temperature is substantially equal to the outside air temperature and the temperature difference between the liquid portion and the non-liquid portion in a container decreases, the liquid level cannot be determined.

Therefore, an object of this technology is to provide an information processing apparatus, an information processing method, and a program capable of easily grasping the state of a liquid level.

### Solutions to Problems

A first aspect of this technology is
an information processing apparatus including
a liquid level state determiner that determines, by using a light reception signal corresponding to light reception intensity of emitted light from a light emitter generated for each of a plurality of light receivers arranged in a vertical direction to face the light emitter, a liquid level state of a liquid provided between the light emitter and the light receivers.

In this technology, the plurality of light receivers arranged in the vertical direction to face the light emitter, for example, the light receivers provided on the upper side and lower side with respect to the optical axis of the light emitter generate light reception signals according to the light reception intensity of emitted light from the light emitter. Furthermore, a plurality of light emitters may be provided in the circumferential direction on a reference plane including the optical axis of the light emitters. The liquid level state determiner determines the liquid level state of a liquid provided between the light emitter and the light receivers by using the light reception signal generated for each light receiver. For example, the liquid level state determiner determines the liquid level state on the basis of a signal level difference between the light reception signal generated by the light receiver arranged on the upper side in the vertical direction and the light reception signal generated by the light receiver arranged on the lower side. Furthermore, in a case where a first light emitter and a second light emitter are provided to face each other, the liquid level state determiner determines the liquid level state on the basis of a first signal level difference between the light reception signal generated by the light receiver arranged on the upper side in the vertical direction with respect to the first light emitter and the light reception signal generated by the light receiver arranged on the lower side in the vertical direction with respect to the second light emitter, and a second signal level difference between the light reception signal generated by the light receiver arranged on the lower side in the vertical direction with respect to the first light emitter and the light reception signal generated by the light receiver arranged on the upper side in the vertical direction with respect to the second light emitter.

Furthermore, light reception adjusters that adjust the light reception direction of the light receivers are further included, and the light reception adjusters adjust the light reception direction according to at least one of the remaining amount of the liquid, the viscosity of the liquid, or the distance between the light emitter and the light receivers. Furthermore, temperature detectors are further provided above and below the light emitter, and the liquid level state determiner determines the liquid level state by further using a temperature detection result detected by the upper temperature detector and a temperature detection result detected by the lower temperature detector.

Moreover, a controller that controls a gripper portion that grips a liquid storage container is included, the light emitter and the light receivers are provided on a gripping surface of the gripper portion, and the controller performs distance measurement from an upper position of the storage container to the inside of the storage container and distance measurement from the upper position to a placement surface of the storage container, and sets a gripping position by the gripper portion on the basis of the distance measurement result.

Furthermore, the liquid level state determiner determines the inclination of the liquid level in the storage container on the basis of, for example, a first signal level difference between a light reception signal generated by the light receiver arranged on the upper side in the vertical direction with respect to the first light emitter and a light reception signal generated by the light receiver arranged on the lower side in the vertical direction with respect to the second light emitter facing the first light emitter, and a second signal level difference between a light reception signal generated by the light receiver arranged on the lower side in the vertical direction with respect to the first light emitter and a light reception signal generated by the light receiver arranged on the upper side in the vertical direction with respect to the second light emitter, and the controller controls the gripper portion such that the storage container takes a predetermined posture with respect to the liquid level on the basis of the determination result of the inclination of the liquid level.

Furthermore, the controller controls pouring of the liquid into the storage container on the basis of the light reception signal generated by the light receiver arranged on the upper side in the vertical direction and the light reception signal generated by the light receiver arranged on the lower side. Furthermore, the controller causes the gripper portion to grip the storage container at a liquid level position of a target water pouring amount in the storage container. Moreover, the controller performs distance measurement from an upper position of a storage container to the inside of the storage container and distance measurement from the upper position to an upper side end portion of the storage container, and set the transporting speed of the storage container according to a difference between the distance measurement results.

A second aspect of this technology is
an information processing method including
determining, by using a light reception signal corresponding to light reception intensity of emitted light from a light emitter generated for each of a plurality of light receivers arranged in a vertical direction to face the light emitter, a liquid level state of a liquid provided between the light emitter and the light receivers with a liquid level state determiner.

A third aspect of this technology is
a program for causing the computer to execute
a procedure of determining, by using a light reception signal corresponding to light reception intensity of emitted light from a light emitter generated for each of a plurality of light receivers arranged in a vertical direction to face the light emitter, a liquid level state of a liquid provided between the light emitter and the light receivers.

Note that the program of the present technology is, for example, a program that can be provided to a general-purpose computer capable of executing various program codes by a storage medium provided in a computer-readable format or a communication medium, for example, a storage medium such as an optical disk, a magnetic disk, or a semiconductor memory, or a communication medium such as a network. By providing such a program in a computer-readable format, processing corresponding to the program is achieved on the computer.

### BRIEF DESCRIPTION OF DRAWINGS

FIG. 1 is a diagram illustrating a configuration of an information processing apparatus.

FIG. 2 is a diagram exemplifying an arrangement of detection units.

FIG. 3 is a diagram schematically illustrating the relationship between liquid level LS and light reception signals with respect to detection units 21-1 and 21-2.

FIG. 4 is a diagram exemplifying a configuration of a robot arm provided with the information processing apparatus.

FIG. 5 is a diagram exemplifying a functional block configuration of the robot arm provided with the information processing apparatus.

FIG. 6 is a flowchart exemplifying the operation performed before a liquid storage container is gripped.

FIG. 7 is a diagram illustrating an example of the operation performed before the liquid storage container is gripped.

FIG. 8 is a flowchart exemplifying the operation of holding the liquid storage container.

FIG. 9 is a diagram illustrating an example of the operation of holding the liquid storage container.

FIG. 10 is a diagram illustrating examples of the operation of holding the liquid storage container.

FIG. 11 is a flowchart exemplifying the operation of pouring water.

FIG. 12 is a diagram exemplifying the operation of pouring water.

### MODE FOR CARRYING OUT THE INVENTION

Hereinafter, a mode for carrying out the present technology will be described. Note that the description will be given in the following order.
1. Configuration of information processing apparatus
2. Operation of information processing apparatus
3. Configuration in a case where information processing apparatus is applied to robot
4. Operation performed in a case where information processing apparatus is applied to robot
4-1. Operation performed before liquid storage container is gripped
4-2. Operation of holding liquid storage container
4-3. Operation of pouring water into storage container
5. Modification

<1. Configuration of Information Processing Apparatus>

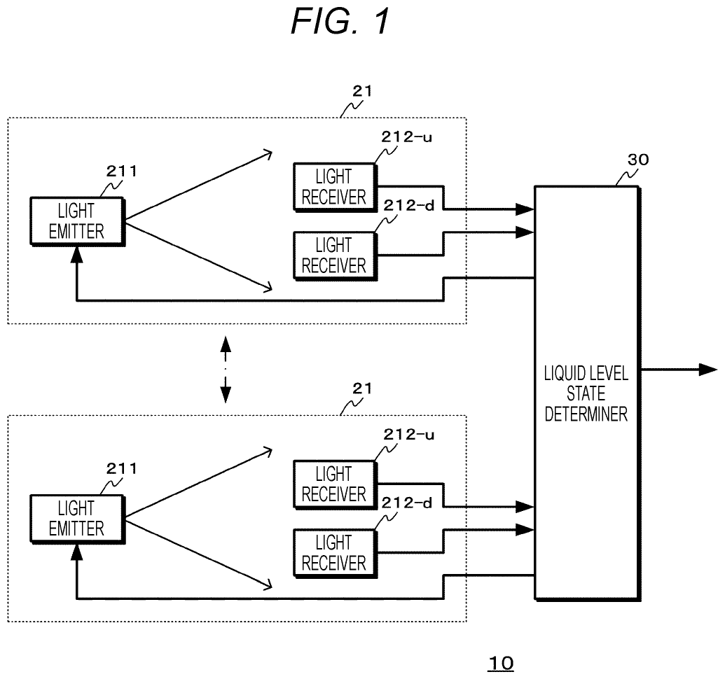

FIG. 1 illustrates a configuration of an information processing apparatus of the present technology. An information processing apparatus 10 includes a detection unit 21 using a light emitter 211 and a plurality of light receivers 212, and a liquid level state determiner 30. Furthermore, one or more detection units 21 are provided.

The light emitter 211 is configured using a light emitting element, for example, a light emitting diode (LED), and emits light.

The plurality of light receivers 212 is arranged in the vertical direction to face the light emitter 211. For example, a light receiver 212u is provided on the upper side with respect to the optical axis of the light emitter 211, and a light receiver 212d is provided on the lower side with respect to the optical axis of the light emitter 211. Furthermore, the light receivers 212u and 212d have sensitivity in the wavelength range of emitted light from the light emitter 211, generate light reception signals corresponding to the light reception intensity of emitted light from the light emitter 211, and output the light reception signals to the liquid level state determiner 30.

Furthermore, for example, a plurality of detection units 21 may be provided such that the light emitter is positioned in the circumferential direction on a reference plane including the optical axis, and the generated light reception signals may be output to the liquid level state determiner 30 for each detection unit.

The liquid level state determiner 30 determines the state of a liquid level on the basis of the light reception signals generated by the detection unit 21.

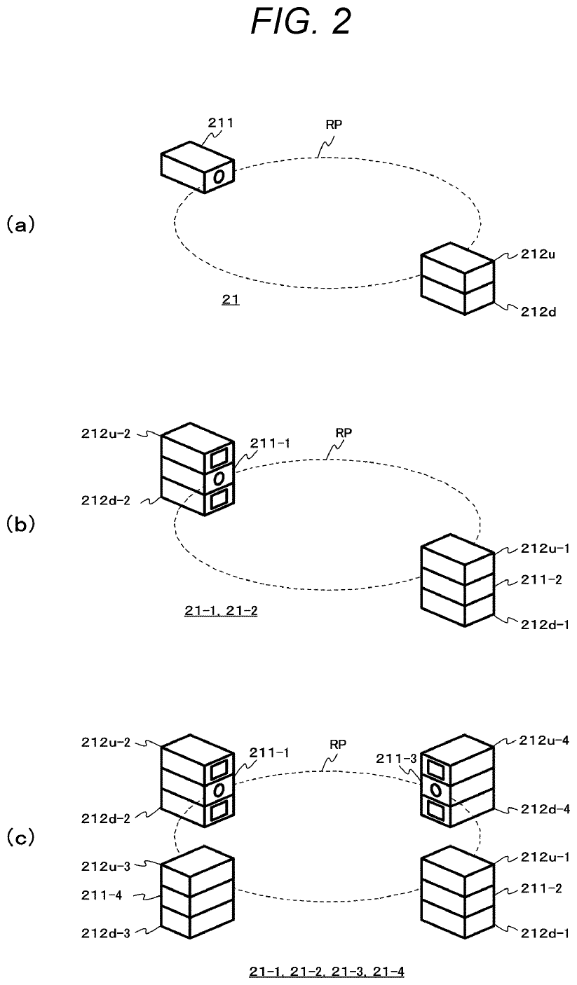

FIG. 2 exemplifies an arrangement of detection units. (a) of FIG. 2 illustrates a case where one detection unit 21 is provided. The detection unit 21 includes the light emitter 211 and the light receivers 212u and 212d arranged in the vertical direction to face the light emitter 211. For example, the light receiver 212u is provided on the upper side and the light receiver 212d is provided on the lower side with respect to a reference plane RP including the optical axis of emitted light from the light emitter 211. Moreover, the light receivers 212u and 212d are configured to face the light emitter 211, and generate light reception signals according to the light reception intensity of emitted light from the light emitter 211.

(b) of FIG. 2 illustrates a case where two detection units 21-1 and 21-2 are provided. The detection unit 21-1 includes a light emitter 211-1 and light receivers 212u-1 and 212d-1 arranged in the vertical direction to face the light emitter 211-1. Furthermore, the detection unit 21-2 includes a light emitter 211-2 and light receivers 212u-2 and 212d-2 arranged in the vertical direction to face the light emitter 211-2. For example, the light receiver 212u-1 is provided on the upper side and the light receiver 212d-1 is provided on the lower side with respect to the reference plane RP including the optical axis of emitted light from the light emitter 211-1. Furthermore, the light emitter 211-1 and the light emitter 211-2 have substantially equal optical axes of emitted light, and the light emitter 211-2 and the light emitter 211-2 are provided to face each other. Moreover, the light receiver 212u-2 is provided on the upper side and the light receiver 212d-2 is provided on the lower side with respect to the reference plane RP including the optical axis of emitted light from the light emitter 211-2. The light receivers 212u-1 and 212d-1 are configured to face the light emitter 211-1, and generate light reception signals according to the light reception intensity of emitted light from the light emitter 211-1. The light receivers 212u-2 and 212d-2 are configured face the light emitter 211-2, and generate light reception signals according to the light reception intensity of emitted light from the light emitter 211-2.

(c) of FIG. 2 illustrates a case where four detection units 21-1, 21-2, 21-3, and 21-4 are provided. The detection units 21-1 and 21-2 are provided as illustrated in (b) of FIG. 2. The detection units 21-3 and 21-4 are configured in a similar manner to the detection units 21-1 and 21-2, and are provided at positions having a phase difference of 90 degrees from the detection units 21-1 and 21-2 in the circumferential direction with the vertical direction with respect to the reference plane RP as a rotation axis (also referred to as the “circumferential direction on a reference plane”) at intermediate positions between the light emitter 211-1 and the light emitter 211-2.

Note that the arrangement of detection units is not limited to that of FIG. 2. For example, a configuration may be such that the plurality of light receivers is provided in the vertical direction on each of the upper side and the lower side with respect to the reference plane RP.

<2. Operation of Information Processing Apparatus>

Next, the operation of the information processing apparatus will be described for a case where the detection units are provided as illustrated in (b) of FIG. 2, for example. Furthermore, a signal indicating a light reception result in the light receiver 212u-1 is referred to as a light reception signal Su-1, a signal indicating a light reception result in the light receiver 212d-1 is referred to as a light reception signal Sd-1, a signal indicating a light reception result in the light receiver 212u-2 is referred to as a light reception signal Su-2, and a signal indicating a light reception result in the light receiver 212d-1 is referred to as a light reception signal Sd-2. Furthermore, the liquid is a liquid that causes attenuation of light.

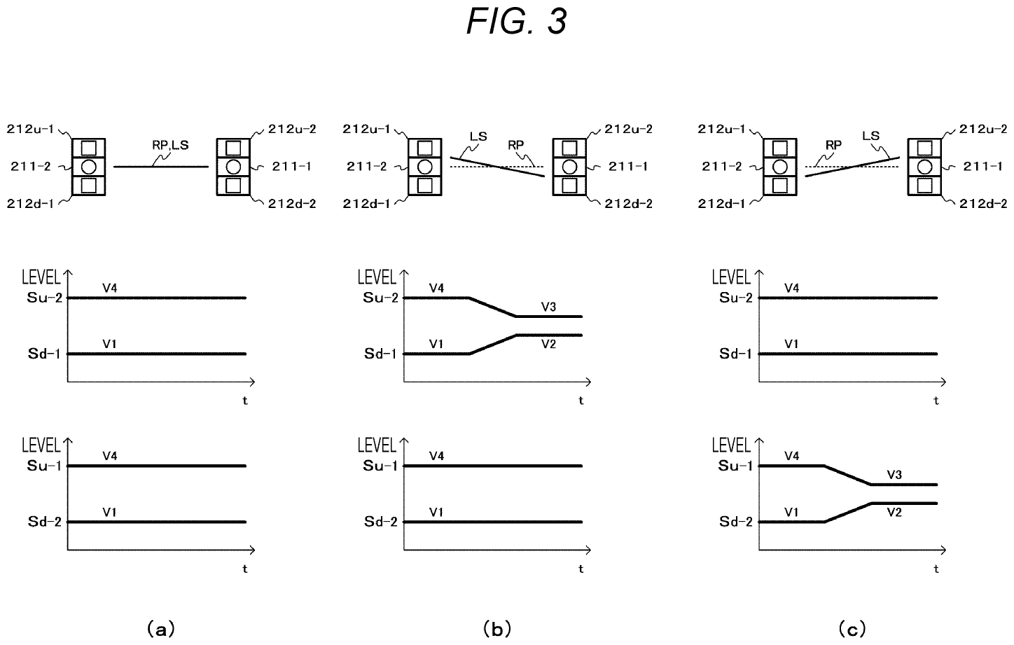

FIG. 3 schematically illustrates the relationship between liquid level LS and light reception signals with respect to the detection units 21-1 and 21-2.

(a) of FIG. 3 exemplifies the light reception signals Su-1, Su-2, Sd-1, and Sd-2 in a case where the reference plane RP and the liquid level LS are substantially equal. The signal level of the light reception signals Su-1 and Su-2 is “V4”, and the signal level of the light reception signals Sd-1 and Sd-2 is “V1”. Note that the emitted light is attenuated by passing through the liquid, and the signal level is “V4>V1”.

(b) of FIG. 3 exemplifies a case where the liquid level LS changes such that, for example, the liquid level is rotated in the clockwise direction in the drawing with respect to the reference plane RP. If the liquid level LS rotates in the clockwise direction, a part of the optical path from the light emitter 211-1 to the light receiver 212d-1 does not contain the liquid. In this case, the signal level of the light reception signal Sd-1 rises from “V1” to, for example, “V2”. Furthermore, the optical path from the light emitter 211-1 to the light receiver 212u-1 does not contain the liquid. In this case, the signal level of the light reception signal Su-1 is maintained at “V4”. Moreover, the optical path from the light emitter 211-2 to the light receiver 212d-2 is kept in a liquid state. In this case, the signal level of the light reception signal Sd-2 is maintained at “V1”. Furthermore, the optical path from the light emitter 211-2 to the light receiver 212u-2 contains the liquid. In this case, the signal level of the light reception signal Su-2 falls from “V4” to, for example, “V3”.

Therefore, the liquid level state determiner 30 can determine that the liquid level LS has changed such that the liquid level is rotated in the clockwise direction with respect to the reference plane RP when it is detected that the signal level difference between the light reception signal Sd-1 and the light reception signal Su-2 has become small.

(c) of FIG. 3 exemplifies a case where the liquid level LS changes such that, for example, the liquid level is rotated in the counterclockwise direction in the drawing with respect to the reference plane RP. If the liquid level LS rotates in the counterclockwise direction, the optical path from the light emitter 211-1 to the light receiver 212d-1 is kept in a liquid state. In this case, the signal level of the light reception signal Sd-1 is maintained at “V1”. Furthermore, a part of the optical path from the light emitter 211-1 to the light receiver 212u-1 contains the liquid. In this case, the signal level of the light reception signal Su-1 falls from “V4” to, for example, “V3”. Moreover, a part of the optical path from the light emitter 211-2 to the light receiver 212d-2 does not contain the liquid. In this case, the signal level of the light reception signal Sd-2 rises from “V1” to, for example, “V2”. Furthermore, a state in which the liquid is not contained in the optical path from the light emitter 211-2 to the light receiver 212u-2 is kept. In this case, the signal level of the light reception signal Su-2 is maintained at “V4”.

Therefore, the liquid level state determiner 30 can determine that the liquid level LS has changed such that the liquid level is rotated in the counterclockwise direction with respect to the reference plane RP when it is detected that the signal level difference between the light reception signal Sd-2 and the light reception signal Su-1 has become small.

As described above, if detection units configured by a light emitter and two light receivers are arranged such that the light emitters face each other, the liquid level state determiner 30 can accurately determine the inclination of a liquid level with respect to the arrangement direction of the light emitters and the light receivers on the basis of the amount of change or the direction of change (increase or decrease) in the signal level of the light receivers. Furthermore, by alternately turning on the light emitter 211-1 and the light emitter 211-2 and generating light reception signals by the light receivers opposing the turned-on light emitter, light reception signals corresponding to the amount of transmission can be accurately generated.

Furthermore, as illustrated in (c) of FIG. 2, if two detection units arranged such that the light emitters face each other are further arranged so as to generate a phase difference of 90 degrees, the inclination of a liquid level can be detected as illustrated in FIG. 3 by the two detection units arranged such that the light emitters face each other. Moreover, the inclination of a phase difference of 90 degrees with respect to the vertical direction of the reference plane RP can be detected by the two detection units arranged so as to generate a phase difference of 90 degrees.

<3. Configuration in a Case where Information Processing Apparatus is Applied to Robot>

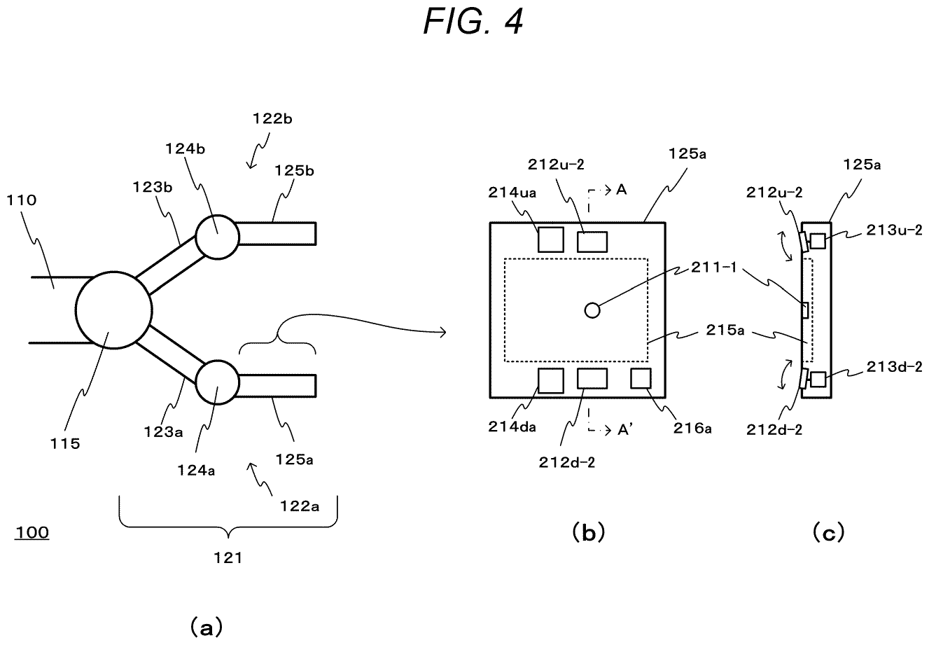

FIG. 4 exemplifies a configuration of a robot arm in a robot provided with the information processing apparatus.

(a) of FIG. 4 is a diagram illustrating a part of the configuration of the robot arm in a simplified manner. A robot arm 100 includes an arm portion 110 and a gripper portion (hand portion) 121. The arm portion 110 and the gripper portion 121 are connected via a joint portion 115, the posture of the gripper portion 121 with respect to the arm portion 110 is adjustable, and the position and posture of the arm portion 110 with respect to the robot main body (not illustrated) are adjustable.

The gripper portion 121 includes a first finger portion 122a and a second finger portion 122b. The first finger portion 122a includes a root portion 123a, a joint portion 124a, and a fingertip portion 125a. One end of the root portion 123a is connected to the joint portion 115, and the other end is connected to the fingertip portion 125a via the joint portion 124a. Furthermore, the second finger portion 122b includes a root portion 123b, a joint portion 124b, and a fingertip portion 125b. One end of the root portion 123b is connected to the joint portion 115, and the other end is connected to the fingertip portion 125b via the joint portion 124b.

In the first finger portion 122a and the second finger portion 122b connected to the joint portion 115, the positions and orientations of the fingertip portion 125a and the fingertip portion 125b are adjustable with respect to the joint portion 115. For example, the first finger portion 122a and the second finger portion 122b operate such that the facing surfaces (gripping surfaces) of the fingertip portion 125a and the fingertip portion 125b are in a substantially parallel state even if the distance between the fingertip portion 125a and the fingertip portion 125b is adjusted. Furthermore, the orientations of the first finger portion 122a and the second finger portion 122b can be adjusted such that the fingertip portion 125a and the fingertip portion 125b are aligned in the horizontal direction or such that the fingertip portion 125a and the fingertip portion 125b are aligned in the vertical direction.

(b) of FIG. 4 exemplifies a configuration of the facing surface of the fingertip portion 125a facing the fingertip portion 125b. The light emitter 211-1 is provided substantially at the center of the facing surface of the fingertip portion 125a, and the light receiver 212u-2 and a temperature detector 214ua are provided above the light emitter 211-1, and the light receiver 212d-2 and a temperature detector 214da are provided below the light emitter. Furthermore, a pressure detector 215a and a distance measurer 216a are provided on the facing surface.

(c) of FIG. 4 is a general diagram of a cross-section of a position A-A′ in (b) of FIG. 4. In the light receiver 212u-2, the direction in which the light reception surface faces can be adjusted by a light reception adjuster 213u-2, and in the light receiver 212d-2, the direction in which the light reception surface faces can be adjusted by a light reception adjuster 213d-2.

Furthermore, the facing surface of the fingertip portion 125b facing fingertip portion 125a is configured similarly to the fingertip portion 125a. Note that a pressure detector and a distance measurer may be provided on only one of the fingertip portion 125a and the fingertip portion 125b.

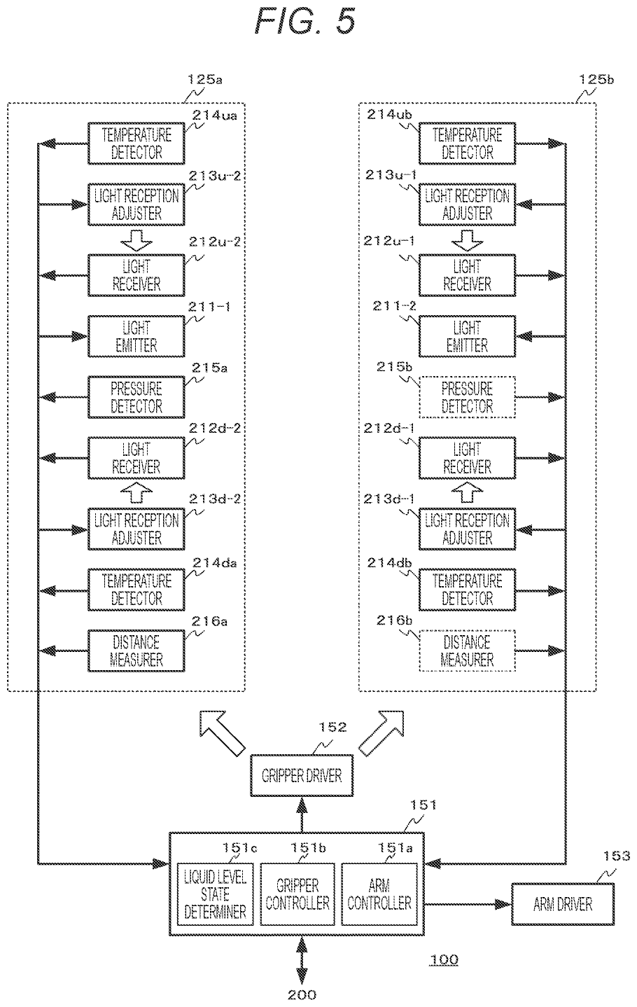

FIG. 5 exemplifies a functional block configuration of the robot arm provided with the information processing apparatus. The fingertip portion 125a of the robot arm 100 includes the light emitter 211-1, the light receivers 212u-2 and 212d-2, the light reception adjusters 213u-2 and 213d-2, the temperature detectors 214ua and 214da, the pressure detector 215a, and the distance measurer 216a. Similarly, the fingertip portion 125b includes the light emitter 211-2, the light receivers 212u-1 and 212d-1, light reception adjusters 213u-1 and 213d-1, and temperature detectors 214ub and 214db. Furthermore, the fingertip portion 125b may include a pressure detector 215b and a distance measurer 216b.

The light emitter 211-1 of the fingertip portion 125a and the light emitter 211-2 of the fingertip portion 125b output emitted light under the control of a controller 151 to be described later.

The light receivers 212u-2 and 212d-2 of the fingertip portion 125a generate light reception signals according to the light reception intensity of emitted light from the light emitter 211-2 of the fingertip portion 125b, and output the light reception signals to the controller 151. Furthermore, the light receivers 212u-1 and 212d-1 of the fingertip portion 125b generate light reception signals according to the light reception intensity of emitted light from the light emitter 211-1 of the fingertip portion 125a, and output the light reception signals to the controller 151.

The light reception adjuster 213u-2 adjusts the light reception direction according to at least one of the remaining amount of the liquid, the viscosity of the liquid, or the distance between the light emitter 211-2 and the light receiver 213u-2 under the control of the controller 151. Similarly, the light reception adjuster 213d-2 adjusts the orientation of the light reception surface of the light receiver 212d-2 under the control of the controller 151. Moreover, the light reception adjusters 213u-1 and 213d-1 adjust the orientation of the light reception surfaces of the light receivers 212u-1 and 212d-1 under the control of the controller 151. The temperature detectors 214ua, 214da, 214ub, and 214db detect the temperature of an object gripped by the fingertip portion 125a and the fingertip portion 125b, and output temperature detection signals indicating the detection results to the controller 151.

The pressure detectors 215a and 215b are configured using a piezoresistive pressure sensor, a capacitive pressure sensor, or the like. The pressure detectors 215a and 215b detect a gripping force when an object is gripped by the fingertip portion 125a and the fingertip portion 125b, and output pressure detection signals indicating the detection results to the controller 151.

The distance measurers 216a and 216b are configured using a distance measurement sensor of an optical type, ultrasonic type, or the like. The distance measurers 216a and 216b output distance measurement signals indicating the distance measurement results to the controller 151.

The robot arm 100 further includes a controller 151, an arm driver 152, and a gripper driver 153. Furthermore, the controller 151 includes an arm controller 151a, a gripper controller 151b, and a liquid level state determiner 151c.

On the basis of an arm control signal from a system controller 200 that controls the operation of the entire robot and the distance measurement signals generated by the distance measurers 216a and 216b, the arm controller 151a generates a drive signal such that the arm portion 110 and the gripper portion 121 are at desired positions and have desired postures, and outputs the drive signal to the arm driver 152. For example, the arm controller 151a generates a drive signal on the basis of the control signal and the distance measurement signals such that the liquid level is between the light receiver 212u-1 (212u-2) and the light receiver 212d-1 (212d-2) of the fingertip portions 125a and 125b, and outputs the drive signal to the arm driver 152.

The gripper controller 151b generates a drive signal on the basis of the pressure detection signals generated by the pressure detectors 215a and 215b such that the fingertip portions 125a and 125b grip the liquid storage container with an appropriate force, and outputs the drive signal to the gripper driver 153.

The liquid level state determiner 151c determines the state of the liquid level on the basis of the light reception signals generated by the light receivers 212u-1, 212d-1, 212u-2, and 212d-2 or the light reception signals and the temperature detection signals generated by the temperature detectors 214ua, 214da, 214ub, and 214db. The liquid level state determiner 151c outputs a determination result of the state of the liquid level (also referred to as a “state determination result”) to the system controller 200.

Moreover, the controller 151 outputs the signals detected in the fingertip portions 125a and 125b and the state determination result generated by the liquid level state determiner 151c to the system controller 200, and the system controller 200 generates an arm control signal on the basis of the signals supplied from the controller 151. For example, the system controller 200 generates an arm control signal such that position control of setting the gripper portion 121 at the position of the storage container and position and posture control of the gripper portion 121 such that the liquid in the storage container does not spill are performed. Note that the liquid level state determiner 151c may adjust the position and posture of the gripper portion 121 such that the liquid in the storage container does not spill by outputting a state determination result to the arm controller 151a or the gripper controller 151b and causing the controllers to generate a drive signal according to the state determination result. Furthermore, the controller 151 may be configured integrally with the system controller 200.

The arm driver 152 drives the arm portion 110 and the gripper portion 121 on the basis of the drive signal generated by the controller 151 to obtain the desired position and posture.

The gripper driver 153 drives the gripper portion 121 on the basis of the drive signal generated by the controller 151 to grip the storage container with an appropriate force.

<4. Operation Performed in a Case Where Information Processing Apparatus is Applied to Robot>

<4-1. Operation Performed Before Liquid Storage Container is Gripped>

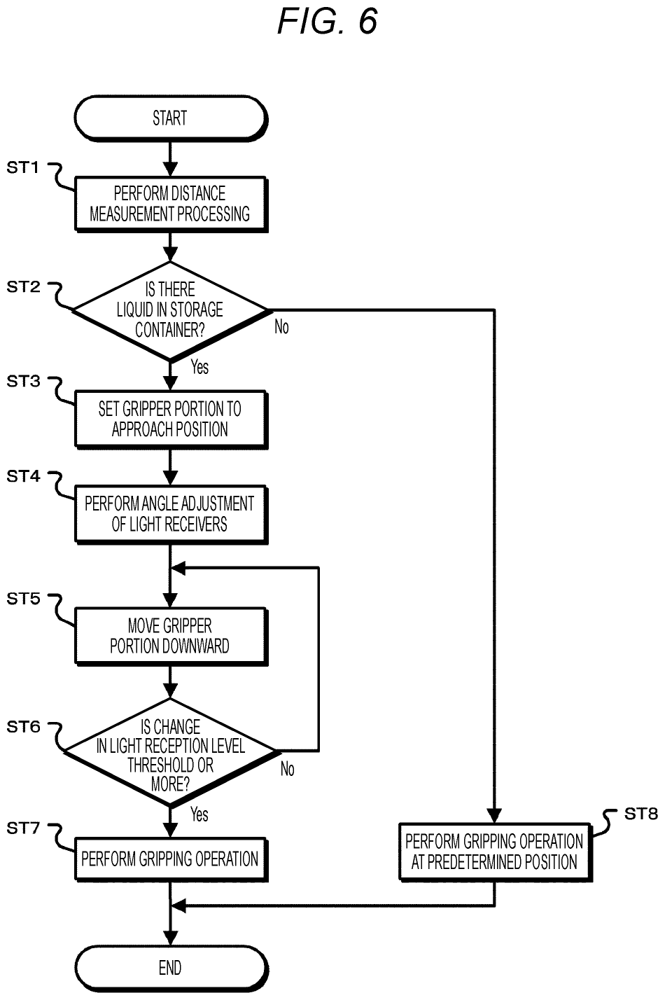

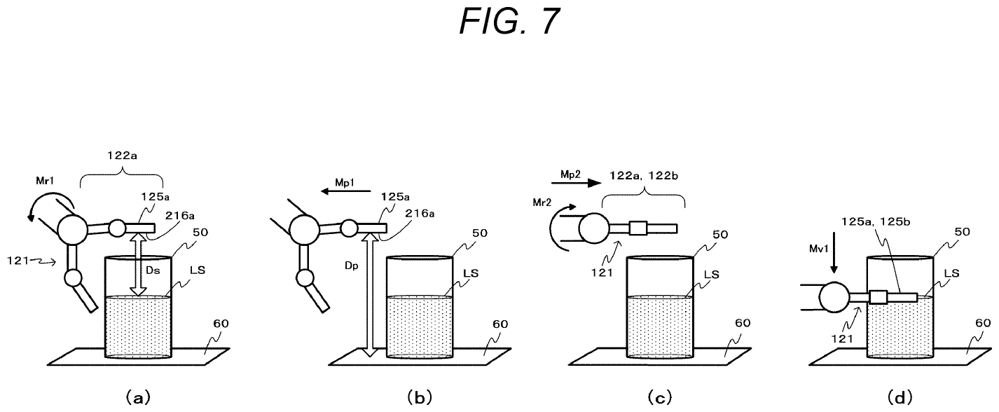

FIG. 6 is a flowchart exemplifying the operation performed before the liquid storage container is gripped. Furthermore, FIG. 7 illustrates an example of the operation performed before the liquid storage container is gripped.

In step ST1 of FIG. 6, the controller performs distance measurement processing. As illustrated in (a) of FIG. 7, the controller 151 rotates the gripper portion 121 in the direction of the arrow Mr1, and sets the distance measurement direction of the distance measurer 216a provided in the fingertip portion 125a of the first finger portion 122a to a downward direction, for example. Furthermore, the controller 151 sets the fingertip portion 125a above a storage container 50. The distance measurer 216a performs distance measurement for the inside of the storage container 50, and measures, for example, a distance Ds to the liquid level LS. Moreover, as illustrated in (b) of FIG. 7, the controller 151 moves the first finger portion 122a in the direction of the arrow Mp1 in parallel to a placement surface 60 of the storage container 50, performs distance measurement by the distance measurer 216a, measures a distance Dp to the placement surface 60, and proceeds to step ST2.

In step ST2, the controller determines whether there is a liquid in the storage container. In a case where the distance difference between the distance Dp to the placement surface and the distance Ds in the storage container measured in step ST1 is larger than a preset threshold, the controller 151 determines that a liquid LS is contained in the storage container 50 and proceeds to step ST3. In a case where the distance difference is equal to or smaller than the threshold, the controller determines that the liquid LS is not contained in the storage container 50 and proceeds to step ST8.

In step ST3, the controller sets the gripper portion to an approach position. As illustrated in (c) of FIG. 7, the controller 151 moves the gripper portion 121 in the directions of the arrows Mr2 and Mp2 to be set to the approach position where the storage container 50 is positioned between the first finger portion 122a and the second finger portion 122b at a position where the first finger portion 122a and the second finger portion 122b are above the storage container 50, and proceeds to step ST4.

In step ST4, the controller performs angle adjustment of the light receivers. The controller 151 adjusts the direction of the light reception surfaces of the light receivers 212u-2 and 212d-2 provided at the fingertip portion 125a of the first finger portion 122a by the light reception adjusters 213u-2 and 213d-2. Furthermore, the controller 151 adjusts the direction of the light reception surfaces of the light receivers 212u-1 and 212d-1 provided at the fingertip portion 125b of the second finger portion 122b by the light reception adjusters 213u-1 and 213d-1.

The light reception adjusters adjust the light reception direction according to at least one of the viscosity of the liquid, the remaining amount of the liquid, or the distance between the light emitter and the light receivers. For example, in a case where the viscosity of the liquid is low, the light reception adjusters 213u-1, 213d-1, 213u-2, and 213d-2 increases the incident angle of emitted light from the light emitter so that a change in the liquid level can be quickly detected. Note that the viscosity of the liquid is set in advance. Furthermore, in a case where the amount of liquid is small and the liquid level is lower than the position of the light emitter, it is possible to generate a light reception signal corresponding to the inclination of the liquid level by directing the direction of the light reception surfaces of the light receivers downward. Furthermore, as the distance between the light emitter and the light receivers becomes smaller, the angle formed by the straight line connecting the light receiver on the upper side and the light emitter and the straight line connecting the light receiver on the lower side and the light emitter increases. Therefore, by adjusting the direction of the light reception surfaces of the light receivers to be the direction of the light emitter, the light reception adjusters can prevent the direction of the light reception surfaces of the light receivers from being a direction different from the direction of the light emitter due to a change in the distance between the light emitter and the light receivers.

In this manner, the light reception adjusters 213u-1, 213d-1, 213u-2, and 213d-2 adjust the direction of the light reception surfaces of the light receivers 212u-1, 212d-1, 212u-2, and 212d-2, and proceeds to step ST5.

In step ST5, the controller moves the gripper portion downward. The controller 151 moves the gripper portion 121 downward (in a direction approaching the placement surface) along the storage container 50 and proceeds to step ST6.

In step ST6, the controller determines whether a change in the light reception level is a threshold or more. For example, in a case where the difference between the light reception signal Su-1 generated by the light receiver 212u-1 and the light reception signal Sd-2 generated by the light receiver 212d-2 and the difference between the light reception signal Sd-1 generated by the light receiver 212d-1 and the light reception signal Su-2 generated by the light receiver 212u-2 are the threshold or more, that is, in a case where the liquid level LS is between the light receiver 212u-1 and the light receiver 212d-1 and between the light receiver 212u-2 and the light receiver 212d-2 and the difference is the threshold or more, the controller 151 proceeds to step ST7. Furthermore, in a case where the gripper portion 121 has not moved such that the liquid level is between the light receiver 212u-1 and the light receiver 212d-1 and between the light receiver 212u-2 and the light receiver 212d-2 and the difference is smaller than the threshold, the controller returns to step ST5 to continue moving the gripper portion 121 in the arrow Mv1.

In step ST7, the controller performs gripping operation. As illustrated in (d) of FIG. 7, when in a state where the liquid level LS is at a position between the light receiver 212u-1 and the light receiver 212d-1 and between the light receiver 212u-2 and the light receiver 212d-2, the controller 151 stops the movement in the direction of the arrow Mv1 and causes the gripper portion 121 to grip the storage container 50. Furthermore, the controller 151 grips the storage container containing the liquid with an appropriate gripping force on the basis of pressure detection signals indicating the detection results of the pressure detector 215a provided at the fingertip portion 125a of the first finger portion 122a and the pressure detector 215b provided at the fingertip portion 125b of the second finger portion 122b.

If it is determined in step ST2 that there is no liquid in the storage container and the controller proceeds to step ST8, the controller performs gripping operation at a predetermined position. Since there is no liquid contained in the storage container, the controller 151 causes the storage container to be gripped at a predetermined position, for example, at a position at a predetermined ratio with respect to the distance from the upper end of the storage container to the placement surface. Furthermore, the controller 151 grips the storage container containing no liquid with an appropriate gripping force on the basis of a pressure detection signal indicating the detection result of the pressure detector 215a provided in the fingertip portion 125a of the first finger portion 122a, or a pressure detection signal indicating the detection result of the pressure detector 215a and a pressure detection signal indicating the detection result of the pressure detector 215b provided in the fingertip portion 125b of the second finger portion 122b.

Note that, although FIG. 7 illustrates the operation performed in a case where the distance measurers 216a and 216b are provided on the facing surfaces of the fingertip portion 125a and the fingertip portion 125b, the distance measurers 216a and 216b may be provided on the lower surfaces of the fingertip portion 125a and the fingertip portion 125b. In this case, the distance to the placement surface and the distance to the liquid level in the storage container (the bottom surface in a case where no liquid is contained) can be measured only by moving the fingertip portion 125a and the fingertip portion 125b in parallel with the placement surface, for example, without rotating the gripper portion 121 in the direction of the arrow Mn1 illustrated in (a) of FIG. 7. Alternatively, the fingertip portion 125a and the fingertip portion 125b can be easily set to positions along the outer surface of the storage container on the basis of the distance to the edge of the storage container or the distance to the placement surface and the distance to the liquid level in the storage container (the bottom surface in a case where no liquid is contained).

In this manner, the controller 151 can grip the storage container 50 with the gripper portion 121 at the position of the liquid level LS on the basis of the light reception signals generated by the light receivers 212u-1, 212d-1, 212u-1, and 212u-2.

<4-2. Operation of Holding Liquid Storage Container>

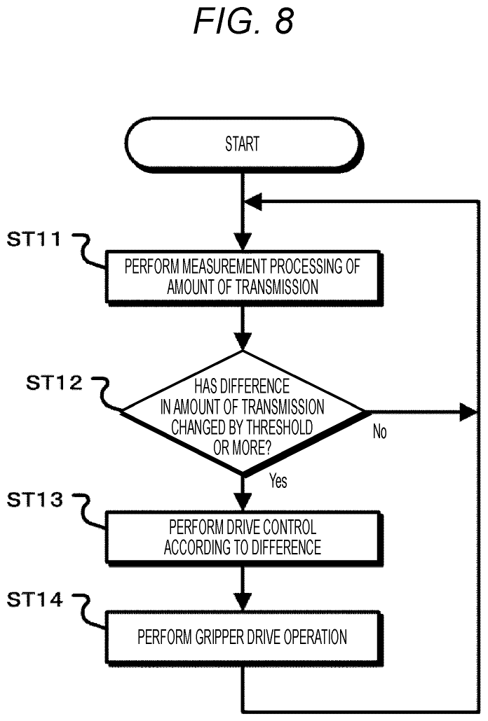

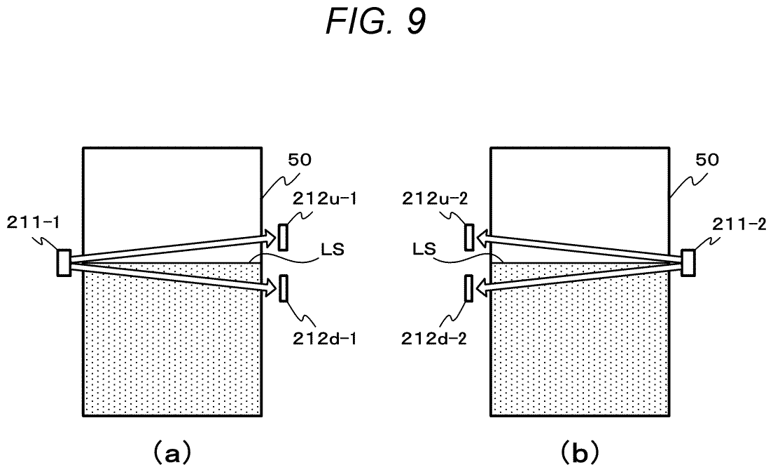

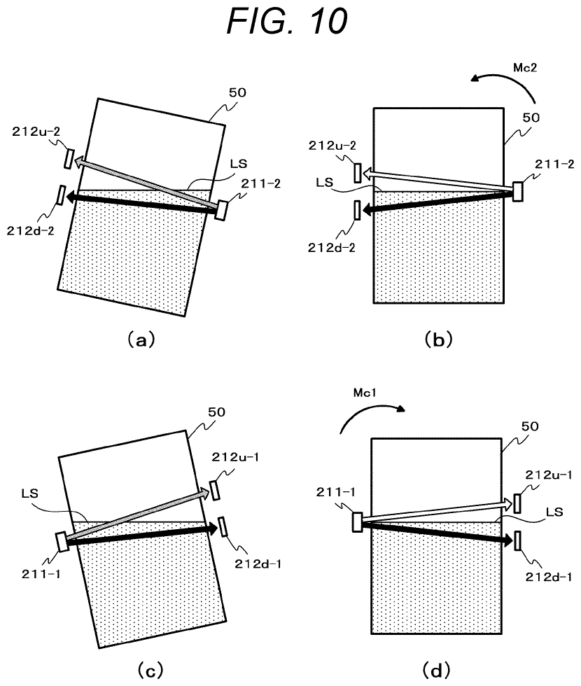

FIG. 8 is a flowchart exemplifying the operation of holding the liquid storage container. Furthermore, FIGS. 9 and 10 illustrate examples of the operation of holding the liquid storage container.

In step ST11 of FIG. 8, the controller performs measurement processing of the amount of transmission. The controller 151 measures, by the light receivers, the amount of transmission of light output from the light emitter. (a) of FIG. 9 illustrates the light emitter 211-1 and the light receivers 212u-1 and 212d-1, and (b) of FIG. 9 illustrates the light emitter 211-2 and the light receivers 212u-2 and 212d-2. The light reception signals generated by the light receivers 212u-1 and 212d-1 (212u-2 and 212d-2) have signal levels corresponding to the amount of transmission of emitted light from the light emitter 211-1 (211-2). For example, the emitted light from the light emitter 211-1 (211-2) enters the light receiver 212d-1 (212d-2) after being attenuated by the liquid. Furthermore, the emitted light from the light emitter 211-1 (211-2) enters the light receiver 212u-1 (212u-2) without being attenuated by the liquid. Therefore, the controller 151 acquires, as the measurement results of the amount of transmission, the light reception signal Su-2 generated by light receiver 212u-2 of the fingertip portion 125a and the light reception signal Sd-2 generated by the light receiver 212d-2. Furthermore, the controller 151 acquires, as the measurement results of the amount of transmission, the light reception signal Su-1 generated by the light receiver 212u-1 of the fingertip portion 125b and the light reception signal Sd-1 generated by the light receiver 212d-1, and proceeds to step ST12.

In step ST12, the controller determines whether a difference in the amount of transmission has changed by a threshold or more. In a case where the change in the difference in the amount of transmission, for example, the difference between the light reception signal Su-1 and the light reception signal Sd-2 and the difference between the light reception signal Sd-1 and the light reception signal Su-2 has changed by the threshold or more, for example, when it is detected that the signal level difference between the light reception signal Sd-1 and the light reception signal Su-2 has become smaller by the threshold or more as illustrated in (b) of FIG. 3, or when it is detected that the signal level difference between the light reception signal Sd-2 and the light reception signal Su-1 has become smaller by the threshold or more as illustrated in (c) of FIG. 3, the controller 151 determines that the difference in the amount of transmission has changed by the threshold or more, and proceeds to step ST13. Furthermore, when it is detected that the signal level difference is larger than the threshold, the controller determines that the difference in the amount of transmission has not changed by the threshold or more, and returns to step ST11.

In step ST13, the controller performs drive control according to the difference. For example, as illustrated in (b) of FIG. 3, in a case where it is detected that the signal level difference between the light reception signal Sd-1 and the light reception signal Su-2 has become smaller by the threshold or more, the liquid level LS is rotated in the clockwise direction with respect to the reference plane RP. Therefore, the controller 151 generates a drive signal for driving the gripper portion 121 such that the liquid level LS is parallel to the reference plane RP, and outputs the drive signal to the gripper driver 153. Furthermore, for example, as illustrated in (c) of FIG. 3, in a case where it is detected that the signal level difference between the light reception signal Sd-2 and the light reception signal Su-1 has become smaller by the threshold or more, the liquid level LS is rotated in the counterclockwise direction with respect to the reference plane RP. Therefore, the controller 151 generates a drive signal for driving the gripper portion 121 such that the liquid level LS is parallel to the reference plane RP, and outputs the drive signal to the gripper driver 153. In this manner, the controller 151 generates a drive signal such that the liquid level LS is parallel to the reference plane RP, and proceeds to step ST14.

Note that the determination of the difference in the amount of transmission and the drive control according to the difference are not limited to the cases illustrated in FIG. 3. For example, as illustrated in FIG. 10, the determination of the difference in the amount of transmission and the drive control according to the difference may be performed on the basis of the light reception signals generated by the plurality of light receivers that receives emitted light from the same light emitter. (a) of FIG. 10 illustrates a case in which rightward inclination has occurred in the storage container 50. In this case, the optical path from the light emitter 211-2 to the light receiver 212u-2 contains the liquid. Therefore, the level difference between the light reception signal generated by the light receiver 212u-2 and the light reception signal generated by the light receiver 212d-2 is smaller compared to a case in which no inclination occurs. (b) of FIG. 10 illustrates a case in which leftward inclination has occurred in the storage container 50. In this case, the optical path from the light emitter 211-1 to the light receiver 212u-1 contains the liquid. Therefore, the level difference between the light reception signal generated by the light receiver 212u-2 and the light reception signal generated by the light receiver 212d-2 is smaller compared to a case in which no inclination occurs. In a case where it is detected that the signal level difference has become smaller by the threshold or more, the controller 151 may generate a drive signal for driving the gripper portion 121 such that the signal level difference is larger than the threshold.

In step ST14, the gripper driver performs gripper drive operation. The gripper driver 153 drives the gripper portion 121 on the basis of the drive signal generated by the controller 151, and causes the gripper portion to operate so as to cancel the inclination of the liquid level. For example, in a case where the storage container 50 is inclined as illustrated in (a) of FIG. 10, the gripper driver 153 drives the gripper portion 121 on the basis of the drive signal generated by the controller 151 and rotates the storage container 50 in the direction of the arrow Mc2, thereby correcting the inclination of the liquid level with respect to the storage container 50. Furthermore, in a case where the storage container 50 is inclined as illustrated in (b) of FIG. 10, the gripper driver 153 drives the gripper portion 121 on the basis of the drive signal generated by the controller 151 and rotates the storage container 50 in the direction of the arrow Mc1, thereby correcting the inclination of the liquid level with respect to the storage container 50. In this manner, the gripper driver 153 drives the gripper portion 121 so as to cancel the inclination of the liquid level, and returns to step ST11.

As described above, the controller 151 determines the state of the liquid level on the basis of the light reception results of the light receivers and operates the gripper portion 121 so as to cancel the inclination of the determined liquid level, whereby the storage container can be continuously gripped such that that the liquid does not spill. For example, if the technology of the present disclosure is applied in a case of transporting a storage container containing a liquid, a robot can transport the storage container containing the liquid so that the liquid does not spill.

<4-3. Operation of Pouring Water into Storage Container>

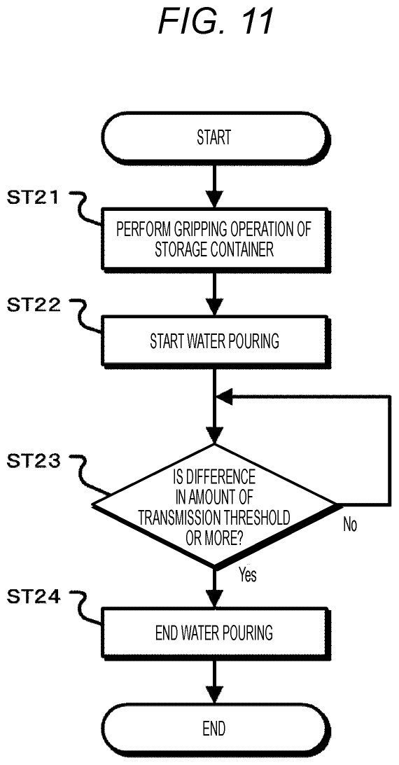

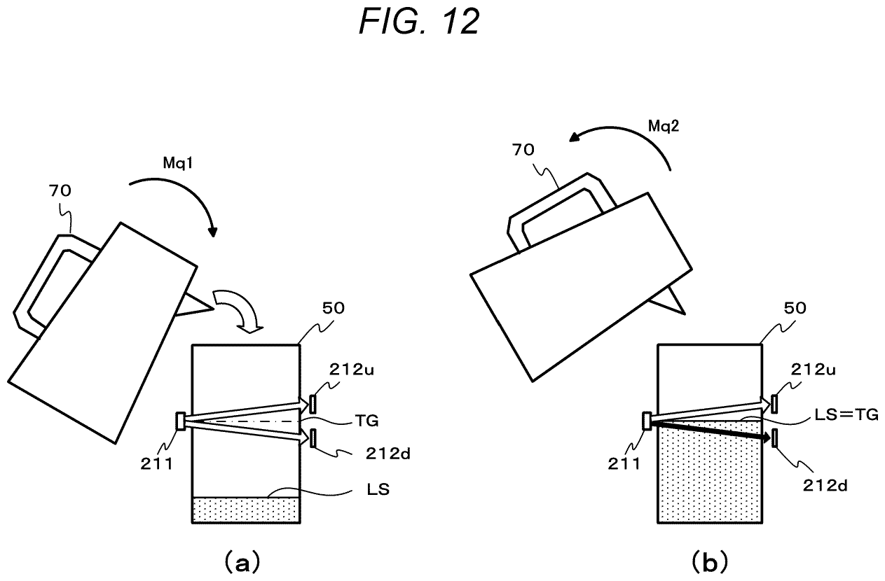

FIG. 11 is a flowchart exemplifying the operation of pouring water into the storage container. Furthermore, FIG. 12 is a diagram illustrating an example of the operation of pouring water into the storage container.

In step ST21, the controller performs gripping operation of the storage container. The controller 151 performs the processing of step ST1, step ST2, and step ST8 of FIG. 6, grips the storage container 50 into which the liquid is poured, and proceeds to step ST22. Note that, as illustrated in (a) of FIG. 12, the gripping position is a liquid level TG of a target amount of liquid poured into the storage container 50 from a water pouring pot 70.

In step ST22, the controller starts water pouring. The controller 151 causes pouring of the liquid into the storage container 50 to be started by rotating the water pouring pot 70 for pouring the liquid into the storage container in the direction of the arrow Mq1 as illustrated in (a) of FIG. 12, for example, and proceeds to step ST22.

In step ST23, the controller determines whether a difference in the amount of transmission has changed by a threshold or more. For example, in a case where the change in the difference in the amount of transmission that is the difference between the light reception signal Su-1 and the light reception signal Sd-2 and the difference between the light reception signal Sd-1 and the light reception signal Su-2 changes by the threshold or more, the controller 151 proceeds to step ST24. Furthermore, in a case where the change in the difference in the amount of transmission does not cause a change by the threshold or more, the controller returns to step ST23.

In step ST24, the controller ends the water pouring. As is apparent from the above description, when it is detected that the signal level difference between the light reception signal Sd-2 and the light reception signal Su-1 has become smaller by the threshold or more, since the position of the liquid level LS is at the liquid level TG of the target amount, for example, the controller 151 rotates the water pouring pot 70 in the direction of the arrow Mq2 and ends the water pouring.

As described above, if the position of the liquid level to be the target amount is gripped by the gripper portion 121 at the time of water pouring, the water pouring can be ended automatically when the liquid level is at the position between the light emitter on the upper side and the light emitter on the lower side in the gripper portion 121, that is, when a target amount of liquid is poured into the storage container 50.

<5. Modification>

Note that, in the above-described embodiment, the case where the information processing apparatus is applied to a robot has been exemplified. However, if the information processing apparatus is applied to a storage device that stores a liquid, a vehicle that transports a liquid, or the like, the state of a liquid level can be easily grasped. Therefore, a liquid can be held or transported such that fluctuation of the liquid level is reduced.

Furthermore, in the above-described embodiment, since temperature detectors are provided, the state of a liquid level may be determined by further using the temperature detection results generated by the temperature detectors. For example, in a case where the temperature difference between the temperature detection result generated by the temperature detector 214ua (214ub) on the upper side and the temperature detection result generated by the temperature detector 214da (214db) on the lower side exceeds a preset threshold, it is determined that the liquid level LS is positioned between the temperature detector 214ua (214ub) and the temperature detector 214da (214db). As described above, by providing temperature detectors, even in a case where the change in the difference in the amount of transmission is small due to the high transparency of liquid, the state of a liquid level can be determined on the basis of the temperature difference between the liquid temperature and the space temperature above the liquid. Furthermore, even in a case where the temperature difference between the liquid temperature and the space temperature above the liquid is small, in a case where the change in the difference in the amount of transmission is not small, the state of a liquid level can be determined on the basis of the change in the signal level of a light reception signal.

Furthermore, the controller may perform distance measurement from an upper position of a storage container to the inside of the storage container and distance measurement from the upper position to an upper side end portion of the storage container, and set the transporting speed of the storage container according to a difference between the distance measurement results. For example, in a case where the difference between the distance measurement results is small, the controller decreases the moving speed since the liquid level is close to the upper side end portion of the storage container and the liquid easily spills. Furthermore, in a case where the difference between the distance measurement results is large, the controller increases the moving speed as compared with the case where the difference between the distance measurement results is small since the liquid does not easily spill.

The series of processing described in the specification can be executed by hardware, software, or a combined configuration of both. In the case of executing processing by software, a program in which a processing sequence is recorded is executed by being installed in a memory in a computer incorporated in dedicated hardware. Alternatively, the program can be executed by being installed in a general-purpose computer capable of executing various types of processing.

For example, the program can be recorded in advance in a hard disk, a solid state drive (SSD), or a read only memory (ROM) as a recording medium. Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-Ray disc (BD) (registered trademark), a magnetic disk, or a semiconductor memory card. Such a removable recording medium can be provided as so-called package software.

Furthermore, in addition to installing the program from the removable recording medium to a computer, the program may be transferred from a download site to the computer wirelessly or by wire via a network such as a local area network (LAN) or the Internet. The computer can receive the program thus transferred and install the program in a recording medium such as a built-in hard disk.

Note that the effects described in the present specification are merely exemplification and are not limited, and there may be additional effects that are not described. Furthermore, the present technology should not be construed as being limited to the embodiment of the technology described above. The embodiment of this technology discloses the present technology in the form of exemplification, and it is obvious those skilled in the art can make modifications and substitutions of the embodiment without departing from the gist of the present technology. That is, in order to determine the gist of the present technology, the claims should be taken into consideration.

Furthermore, the information processing apparatus of the present technology can also take the following configurations.

(1) An information processing apparatus including
a liquid level state determiner that determines, by using a light reception signal corresponding to light reception intensity of emitted light from a light emitter generated for each of a plurality of light receivers arranged in a vertical direction to face the light emitter, a liquid level state of a liquid provided between the light emitter and the light receivers.

(2) The information processing apparatus according to (1), in which the light receivers are provided on an upper side and a lower side with respect to an optical axis of the light emitter.

(3) The information processing apparatus according to (2), in which a plurality of the light emitter is provided in a circumferential direction on a reference plane including an optical axis of the light emitter.

(4) The information processing apparatus according to any one of (1) to (3), in which the liquid level state determiner determines the liquid level state on the basis of a signal level difference between a light reception signal generated by a light receiver arranged on an upper side in the vertical direction and a light reception signal generated by a light receiver arranged on a lower side.

(5) The information processing apparatus according to any one of (1) to (4), in which the liquid level state determiner determines the liquid level state on the basis of a first signal level difference between a light reception signal generated by a light receiver arranged on an upper side in the vertical direction with respect to a first light emitter and a light reception signal generated by a light receiver arranged on a lower side in the vertical direction with respect to a second light emitter facing the first light emitter, and a second signal level difference between a light reception signal generated by a light receiver arranged on a lower side in the vertical direction with respect to the first light emitter and a light reception signal generated by a light receiver arranged on an upper side in the vertical direction with respect to the second light emitter.

(6) The information processing apparatus according to any one of (1) to (5), in which light reception adjusters that adjust a light reception direction of the light receivers are further included.

(7) The information processing apparatus according to (6), in which the light reception adjusters adjust a light reception direction according to at least one of viscosity of the liquid, a remaining amount of the liquid, or a distance between the light emitter and the light receivers.

(8) The information processing apparatus according to any one of (1) to (7), in which temperature detectors are further provided above and below the light emitter, and
the liquid level state determiner determines a liquid level state by further using a temperature detection result detected by the above temperature detector and a temperature detection result detected by the below temperature detector.

(9) The information processing apparatus according to any one of (1) to (8), in which
a controller that controls a gripper portion that grips a storage container of the liquid is further included,
the light emitter and the light receivers are provided on a gripping surface of the gripper portion, and
the controller performs distance measurement from an upper position of the storage container to an inside of the storage container and distance measurement from the upper position to a placement surface of the storage container, and sets a gripping position by the gripper portion on the basis of a distance measurement result.

(10) The information processing apparatus according to (9), in which
the liquid level state determiner determines an inclination of a liquid level in the storage container on the basis of a first signal level difference between a light reception signal generated by a light receiver arranged on an upper side in the vertical direction with respect to the first light emitter and a light reception signal generated by a light receiver arranged on a lower side in the vertical direction with respect to the second light emitter facing the first light emitter, and a second signal level difference between a light reception signal generated by a light receiver arranged on a lower side in the vertical direction with respect to the first light emitter and a light reception signal generated by a light receiver arranged on an upper side in the vertical direction with respect to the second light emitter, and
the controller controls a gripper portion such that the liquid level takes a predetermined posture with respect to the storage container on the basis of a determination result of an inclination of the liquid level determined by the liquid level state determiner.

(11) The information processing apparatus according to (9) or (10), in which the controller controls pouring of the liquid into the storage container on the basis of a light reception signal generated by a light receiver arranged on an upper side in the vertical direction and a light reception signal generated by a light receiver arranged on a lower side.

(12) The information processing apparatus according to (11), in which the controller causes the gripper portion to grip the storage container at a liquid level position of a target water pouring amount in the storage container.

(13) The information processing apparatus according to (9) or (10), in which the controller performs distance measurement from an upper position of the storage container to an inside of the storage container and distance measurement from the upper position to an upper side end portion of the storage container, and sets a transporting speed of the storage container according to a difference between distance measurement results.

### REFERENCE SIGNS LIST

10 Information processing apparatus
21, 21-1, 21-2, 21-3, 21-4 Detection unit
30 Liquid level state determiner
100 Robot arm
110 Arm portion
115 Joint portion
121 Gripper portion
122a First finger portion
122b Second finger portion
123a, 123b Root portion
124a, 124b Joint portion
125a, 125b Fingertip portion
151 Controller
151a Liquid level state determiner
151b Gripper controller
151c Arm controller
152 Gripper driver
153 Arm driver
200 System controller
211, 211-1, 211-2 Light emitter
212, 212d, 212d-1, 212d-2, 212u, 212u-1, 212u-2 Light receiver
213d-1, 213d-2, 213u-1, 213u-2 Light reception adjuster
214da, 214ua, 214db, 214ub Temperature detector
215a, 215b Pressure detector
216a, 216b Distance measurer

1. An information processing apparatus comprising
a liquid level state determiner that determines, by using a light reception signal corresponding to light reception intensity of emitted light from a light emitter generated for each of a plurality of light receivers arranged in a vertical direction to face the light emitter, a liquid level state of a liquid provided between the light emitter and the light receivers.

2. The information processing apparatus according to claim 1, wherein
the light receivers are provided on an upper side and a lower side with respect to an optical axis of the light emitter.

3. The information processing apparatus according to claim 2, wherein
a plurality of the light emitter is provided in a circumferential direction on a reference plane including an optical axis of the light emitter.

4. The information processing apparatus according to claim 1, wherein
the liquid level state determiner determines the liquid level state on a basis of a signal level difference between a light reception signal generated by a light receiver arranged on an upper side in the vertical direction and a light reception signal generated by a light receiver arranged on a lower side.

5. The information processing apparatus according to claim 1, wherein
the liquid level state determiner determines the liquid level state on a basis of a first signal level difference between a light reception signal generated by a light receiver arranged on an upper side in the vertical direction with respect to a first light emitter and a light reception signal generated by a light receiver arranged on a lower side in the vertical direction with respect to a second light emitter facing the first light emitter, and a second signal level difference between a light reception signal generated by a light receiver arranged on a lower side in the vertical direction with respect to the first light emitter and a light reception signal generated by a light receiver arranged on an upper side in the vertical direction with respect to the second light emitter.

6. The information processing apparatus according to claim 1, wherein
light reception adjusters that adjust a light reception direction of the light receivers are further included.

7. The information processing apparatus according to claim 6, wherein
the light reception adjusters adjust a light reception direction according to at least one of viscosity of the liquid, a remaining amount of the liquid, or a distance between the light emitter and the light receivers.

8. The information processing apparatus according to claim 1, wherein
temperature detectors are further provided above and below the light emitter, and
the liquid level state determiner determines a liquid level state by further using a temperature detection result detected by the above temperature detector and a temperature detection result detected by the below temperature detector.

9. The information processing apparatus according to claim 1, wherein
a controller that controls a gripper portion that grips a storage container of the liquid is further included,
the light emitter and the light receivers are provided on a gripping surface of the gripper portion, and
the controller performs distance measurement from an upper position of the storage container to an inside of the storage container and distance measurement from the upper position to a placement surface of the storage container, and sets a gripping position by the gripper portion on a basis of a distance measurement result.

10. The information processing apparatus according to claim 9, wherein
the liquid level state determiner determines an inclination of a liquid level in the storage container on a basis of a first signal level difference between a light reception signal generated by a light receiver arranged on an upper side in the vertical direction with respect to the first light emitter and a light reception signal generated by a light receiver arranged on a lower side in the vertical direction with respect to the second light emitter facing the first light emitter, and a second signal level difference between a light reception signal generated by a light receiver arranged on a lower side in the vertical direction with respect to the first light emitter and a light reception signal generated by a light receiver arranged on an upper side in the vertical direction with respect to the second light emitter, and
the controller controls a gripper portion such that the liquid level takes a predetermined posture with respect to the storage container on a basis of a determination result of an inclination of the liquid level determined by the liquid level state determiner.

11. The information processing apparatus according to claim 9, wherein
the controller controls pouring of the liquid into the storage container on a basis of a light reception signal generated by a light receiver arranged on an upper side in the vertical direction and a light reception signal generated by a light receiver arranged on a lower side.

12. The information processing apparatus according to claim 11, wherein
the controller causes the gripper portion to grip the storage container at a liquid level position of a target water pouring amount in the storage container.

13. The information processing apparatus according to claim 9, wherein
the controller performs distance measurement from an upper position of the storage container to an inside of the storage container and distance measurement from the upper position to an upper side end portion of the storage container, and sets a transporting speed of the storage container according to a difference between distance measurement results.

14. An information processing method comprising
determining, by using a light reception signal corresponding to light reception intensity of emitted light from a light emitter generated for each of a plurality of light receivers arranged in a vertical direction to face the light emitter, a liquid level state of a liquid provided between the light emitter and the light receivers with a liquid level state determiner.

15. A program for causing a computer to execute detection of a liquid level state of a liquid,
the program causing the computer to execute
a procedure of determining, by using a light reception signal corresponding to light reception intensity of emitted light from a light emitter generated for each of a plurality of light receivers arranged in a vertical direction to face the light emitter, a liquid level state of a liquid provided between the light emitter and the light receivers.
